(19) United States
(12) Patent Application Publication
(10) Pub. No.: US 2019/0000293 A1
(43) Pub. Date: Jan. 3, 2019

(54) COMPOSTABLE AND BIODEGRADABLE SCRUBBING SPONGE

(71) Applicant: Naturezway, Inc., City of Commerce, CA (US)

(72) Inventor: Habib Rostami, Irvine, CA (US)

(73) Assignee: Naturezway, Inc., City of Commerce, CA (US)

(21) Appl. No.: 15/702,422

(22) Filed: Sep. 12, 2017

Related U.S. Application Data
(60) Provisional application No. 62/393,586, filed on Sep. 12, 2016.

(51) Int. Cl. A47L 13/16; C08L 67/04; B29C 47/00

(52) U.S. Cl. CPC A47L 13/16; C08L 2201/06; B29C 47/0026; C08L 67/04

(57) ABSTRACT

An environmentally friendly fully compostable and biodegradable scrubbing sponge/pad in the form of a new scrubbing layer of material that can be secured to an existing liquid absorbent sponge layer of material, or alternatively, it can be formed having only a single scrubbing layer of material without it being secured to another sponge layer. Whichever form is used for the invention, the scrubbing layer referred to here as “bi-component” material is made from multi-layers of biopolymer fiber materials known by the brand names of Ecoview™ (offered by BASF™ company), or Ecoflex™ (offered by BASF™ company), in combination with single or multi-layers of PLA (Polylactic Acid) polymer material. The scrubbing layer may be made from extruded sheets or from non-woven or woven methods of said bi-component materials alone or in combination with natural fiber to form the scrubbing surface. In accordance with the present invention, the liquid absorbent sponge layer as well as the scrubbing layer (and any other components) used in the invention are all made from completely compostable and biodegradable materials giving the scrubbing sponge its environmentally friendly characteristic.

### CROSS-REFERENCE TO RELATED APPLICATION

This application claims the benefit of U.S. Provisional Application Ser. No. 62/393,586 filed Sep. 12, 2016, the content of which is incorporated by reference.

### BACKGROUND OF THE INVENTION

The present invention generally relates to the field of cleaning devices. This invention generally relates to cleaning and scrubbing sponges with good water or liquid absorption capabilities that are used for cleaning impervious surfaces, and specifically to compostable and biodegradable scrubbing sponges that are used in such cleaning applications.

Cleaning sponges exist that are simply made of a single layer of soft, liquid absorbent material that can readily absorb water, soap, and/or other cleaning liquid solution for cleaning household surfaces. Another type of sponge exists that allows for both cleaning and scrubbing of household surfaces, where scrubbing sponges usually comprise and are made of multiple layers—a softer sponge layer, and a somewhat harder scrubbing layer. The sponge layer, which is typically thicker and softer and makes up the bulk of the scrubbing sponge, is made from softer material that can absorb and retain water or other water and soap/detergent solution. The scrubbing layer has a sufficiently low abrasive characteristic that is suitable for cleaning the surface or object being cleaned, and can be made of polyester/plastic components in combination with natural fiber abrasives. The sponge layer and the scrubbing layer are joined, secured, attached, or fused together in a variety of ways known to those skilled in the art (e.g., by heat sealing, by glue, or by sewing).

Currently existing sponges or pads for scrubbing and cleaning are typically made from plastic polymers or cellulose wood fibers. For example, some existing cleaning sponges are non-woven, or woven, and/or made from extruded sheets of plastic-based materials such as polyester, polypropylene, and/or polyurethane. These existing plastic-based sponges are not compostable or biodegradable, making them not environmentally friendly in that they would take many years, perhaps hundreds to thousands of years, before they would decompose in landfills or other trash disposal areas. Alternatively, cleaning sponges (without scrubbing capability) are available that are made from natural cellulose materials made from wood fiber or plant fiber, which makes them compostable and biodegradable as compared to plastic-based scrubbing or cleaning sponges. Also, there exists cleaning sponges (without scrubbing capability) made from manufactured cellulose fibers such as recycled natural wood chips or pulp called viscose material, which are also compostable and biodegradable.

In such existing designs for scrubbing sponges or pads, due to the nature and composition of the materials used for the different layers and their chosen physical construction, a drawback of such products is that the scrubbing sponge or pad will not be compostable and biodegradable. As such, when existing scrubbing sponges or pads have completed their use and are then disposed as part of trash that ends up in landfills, their inability to be compostable and biodegradable contributes to accumulation of trash and harming of the environment, rendering them not environmentally friendly, whereas one would desire scrubbing sponges to be environmentally friendly.

In view of the foregoing, there is a need for, and what was heretofore unavailable, a scrubbing sponge having a design and composition that can lend itself to being manufactured economically, that would be suitable for its cleaning and scrubbing purposes, and which would be compostable and biodegradable. The present invention fulfills these and other needs.

### SUMMARY OF THE INVENTION

Briefly, and in general terms, the present invention is directed to compostable and biodegradable scrubbing sponges or scrubbing pads for use in cleaning as well as scrubbing various surfaces in household applications.

The scrubbing sponge or scrubbing pad of the present invention generally takes the form of having either a scrubbing layer of material that can be secured to a sponge layer of material, or alternatively, it can be formed having only a scrubbing layer of material without it being secured to another sponge layer. Whichever form is used for the invention, the scrubbing layer which will be referred to here as “bi-component” is made from multi-layers of biopolymer fiber materials known by the brand names of Ecoview™ (offered by BASF™ company), or Ecoflex™ (offered by BASF™ company), in combination with single or multi-layers of PLA (Polylactic Acid) polymer material. The scrubbing layer of the pad may be made from extruded sheets, or alternatively, from non-woven or woven methods of said bi-component materials alone or in combination with natural fiber to form the scrubbing surface.

With the scrubbing sponge of the present invention taking the form of a scrubbing layer secured to a sponge layer—where an example of the latter sponge layer would be an existing cellulose fiber sponge—the scrubbing layer would be secured or attached to the sponge layer by use of a heat lamination process that is well known by those skilled in the art. Alternatively, in the form of the invention where the scrubbing layer is made of a combination of non-woven or woven methods with natural fiber material, such scrubbing layer can be stitched or sewn over and around the cellulose fiber liquid-absorbent material.

Other features and advantages of the invention will become apparent from the following detailed description, taken in conjunction with the accompanying drawings, which illustrate, by way of example, the features of the invention.

### BRIEF DESCRIPTION OF THE DRAWINGS

FIG. 1A is a top perspective view of an existing cellulose cleaning sponge.

FIG. 1B is a top plan view of a scrubbing layer for use in the scrubbing sponge or pad of present invention where the scrubbing layer is made from extruded sheet of bi-component material.

FIG. 1C is a top plan view of a scrubbing layer for use in the scrubbing sponge or pad of present invention where the scrubbing layer is made from woven or non-woven bi-component material.

FIG. 2A is a top perspective view of the scrubbing sponge of the present invention where a scrubbing layer above is heat laminated to the sponge layer below and the scrubbing layer is made from woven or non-woven bi-component material with or without natural fiber.

FIG. 2B is a top perspective view of the scrubbing sponge of the present invention where a pair of scrubbing layers—one above and one below—are heat laminated to the sponge layer located there between and the scrubbing layer is made from woven or non-woven bi-component material with or without natural fiber.

FIG. 3A is a top perspective view of the scrubbing sponge of the present invention where a scrubbing layer above is heat laminated to the sponge layer below and the scrubbing layer is made from extruded sheet of bi-component material with or without natural fiber.

FIG. 3B is a top perspective view of the scrubbing sponge of the present invention where a pair of scrubbing layers—one above and one below—are heat laminated to the sponge layer located there between and the scrubbing layer is made from extruded sheet of bi-component material with or without natural fiber.

FIG. 4 is a top perspective view of the scrubbing sponge of the present invention showing the scrubbing layer made by woven or non-woven bi-component material with or without natural fiber, with the scrubbing layer stitched or sewn around the sponge material.

FIG. 5 is a cross-sectional view of the scrubbing sponge shown in FIG. 4 taken along the line 5-5.

### DETAILED DESCRIPTION OF THE INVENTION

As shown in the drawings for purposes of illustration, the present invention is directed to a compostable and biodegradable scrubbing sponge or scrubbing pad. The scrubbing sponge or pad of the present invention is designed and made as having either a scrubbing layer of material that can be secured, joined, or connected to a sponge layer of material, or alternatively, it can be made with only a single scrubbing layer of material without it being secured to another sponge layer.

In accordance with the scrubbing sponge of the present invention being formed from a combination of a liquid absorbent sponge layer and a scrubbing layer, one example of the sponge layer can be an existing cellulose sponge that has good water or liquid absorption capabilities and is compostable and biodegradable. For the new scrubbing layer, which is and will be referred hereto as “bi-component” material, it is made from multi-layers of biopolymer materials that are fully compostable and biodegradable and which are known and marketed by the brand names of Ecoview™ (offered by BASF™ company), or Ecoflex™ (offered by BASF™ company), in combination with single or multi-layers of PLA (Polylactic Acid) polymer material. The scrubbing layer of the invention may be made either from extruded sheets or from non-woven or woven forms of said bi-component materials, alone or in combination with natural fiber to form the scrubbing surface that would be capable of having the necessary abrasive qualities to clean dirty surfaces. In accordance with the present invention, the liquid absorbent sponge layer as well as the scrubbing layer (and any other components) used in the invention are all made from completely compostable and biodegradable materials giving the scrubbing sponge its environmentally friendly characteristic.

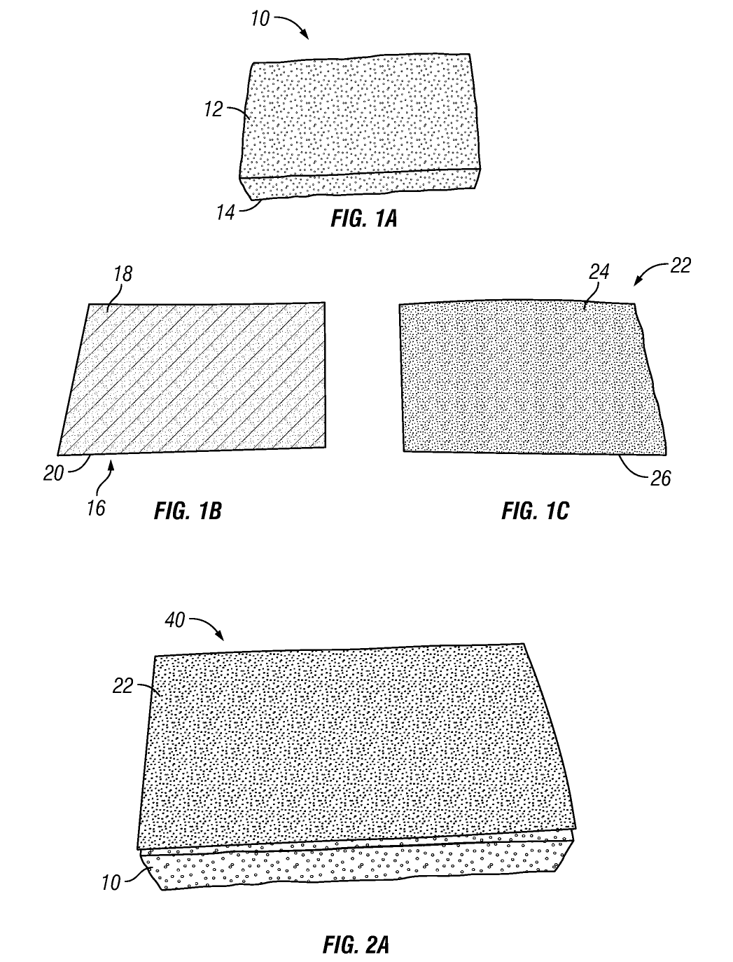

In FIG. 1A, an existing cellulose sponge 10 is shown with an upper surface 12 and a lower surface 14, which can be utilized as a liquid absorbent sponge layer. The sponge 10 is combined with a new scrubbing layer where certain examples of “bi-component” materials described above for the scrubbing layer are shown. In FIG. 1B, one example of such scrubbing layer 16, having an upper surface 18 and a lower surface 20, is illustrated in the format of an extruded sheet of bi-component material. In FIG. 1C, another example of such scrubbing layer 22 having an upper surface 24 and a lower surface 26, is illustrated in the form of woven or non-woven bi-component material. Alternatively, the present invention can take the form of only having a single scrubbing layer of material as those shown in FIG. 1B and FIG. 1C, where the new bi-component scrubbing material works by itself to provide scrubbing capabilities without being secured to or joined with a sponge layer.

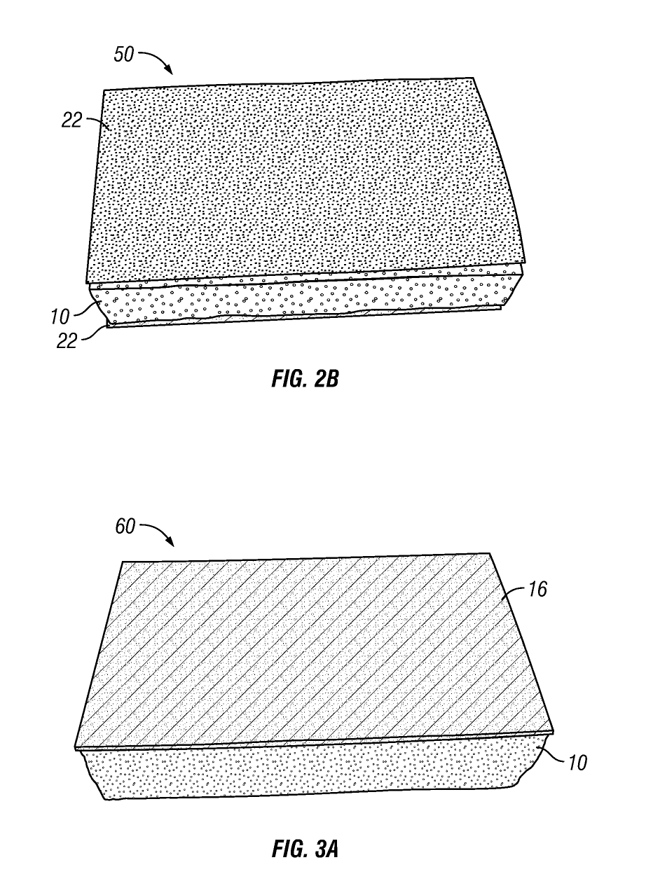

In FIG. 2A, the scrubbing sponge 40 of the present invention is shown in the form of a scrubbing layer 22 made of non-woven or woven bi-component material (alone or in combination with natural fiber), which by use of a heat lamination process is secured to or joined with an existing liquid absorbent sponge 10 such as a cellulose sponge.

In FIG. 2B, the scrubbing sponge 50 of the present invention is shown in a very similar fashion as in FIG. 2A and using the same types of materials and heat lamination process, except that in FIG. 2B there are two scrubbing layers 22, one located above and a second located below the liquid absorbent sponge 10.

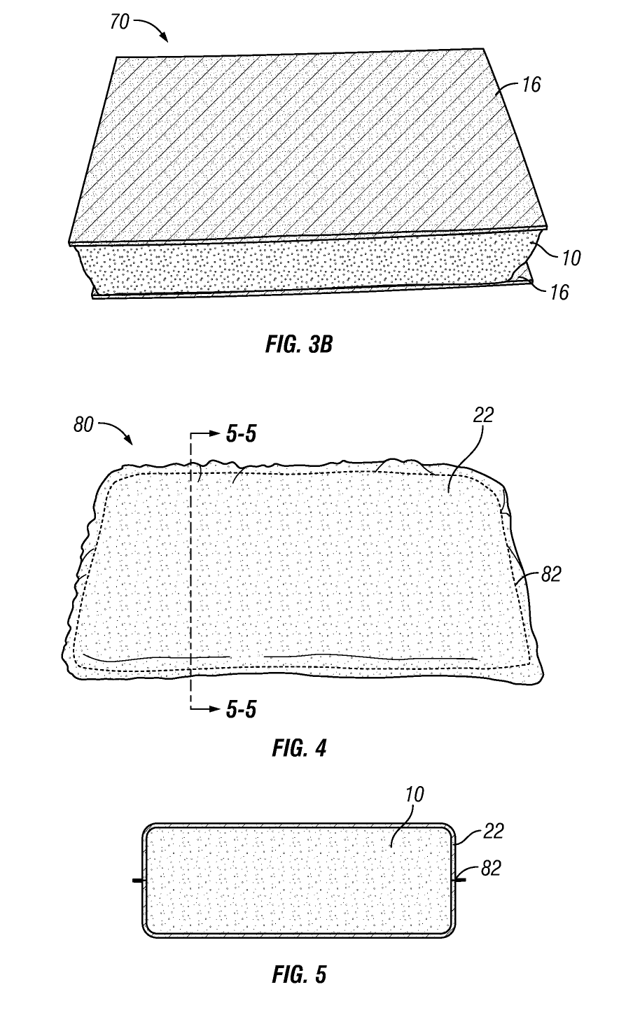

In FIG. 3A, the scrubbing sponge 60 of the present invention is shown in the form of a scrubbing layer 16 made of extruded sheet of bi-component material (that can be with or without natural fiber), where the scrubbing layer is heat laminated onto an existing liquid absorbent sponge 10 such as a cellulose sponge.

In FIG. 3B, the scrubbing sponge 70 of the present invention is shown in a very similar fashion as in FIG. 3A and by use of the same types of materials and heat lamination process, except that in FIG. 3B there are two scrubbing layers 16, one located above and another located below the liquid absorbent sponge 10.

In FIG. 4, the scrubbing sponge 80 of the invention is shown in the form of a scrubbing layer 22 that can be made of bi-component woven or non-woven material (with or without natural fiber), where the scrubbing layer 22 is sewn or stitched near its edges along stitching line 82 around an existing liquid absorbent sponge 10 such as a cellulose sponge. FIG. 5 is a cross-sectional view of the invention shown in FIG. 4, taken along the line 5-5, showing the liquid absorbent sponge 10 in the center surrounded by the scrubbing layer 22 that is sewn or stitched along its edge 82 and around the sponge 10.

Although heat lamination or sewing are shown in the exemplary figures for joining, securing, or attaching the scrubbing layer of the invention to a sponge layer, alternative mechanisms could be by use of glue to secure said layers or by use of other mechanisms and means known to those skilled in the art.

Those skilled in the art of manufacturing mechanical devices such as the disclosed cleaning device can determine, without undue experimentation, the appropriate dimensions, geometries, materials, and other features of the compostable scrubbing sponge/pad of the invention. Other embodiments in accordance with the present invention may be employed as is known to those skilled in the art of designing and/or manufacturing of cleaning devices. Similarly, those skilled in the art will understand from the disclosure herein that various modifications to the components of the scrubbing sponge/pad can be made without departing from the scope of the invention. More specifically, the present invention is not limited to any particular method of forming or manufacturing the compostable scrubbing sponge/pad of the invention and it components.

While certain aspects of the invention have been illustrated and described herein in terms of its use as a compostable and biodegradable scrubbing sponge/pad, modifications and improvements to the disclosed apparatus may be made without departing from the scope of the invention. Accordingly, the scope of the invention is not intended to be limited by, for example, but not limited to, the details of the drawings/figures/photos and the appended claims.

I claim:

1. A scrubbing sponge, comprising:
a scrubbing layer made from 100% compostable and biodegradable biopolymer fiber material in extruded sheet form and made in combination with Polylactic Acid (PLA) polymer materials;
a liquid absorbent sponge layer made from 100% compostable and biodegradable liquid absorbent material;
wherein the scrubbing layer and the sponge layer are secured together.

2. The scrubbing sponge of claim 1, wherein the scrubbing layer is heat laminated to the sponge layer.

3. The scrubbing sponge of claim 1, wherein the scrubbing layer is sewn around and over the sponge layer.

4. A scrubbing sponge, comprising:
a scrubbing layer made from 100% compostable and biodegradable biopolymer fiber material;
a liquid absorbent sponge layer made from 100% compostable and biodegradable liquid absorbent material;
wherein the scrubbing layer and the sponge layer are secured together.

5. The scrubbing sponge of claim 4, wherein the scrubbing layer is made in combination with Polylactic Acid (PLA) polymer materials.

6. The scrubbing sponge of claim 4, wherein the scrubbing layer is made in the form of at least one extruded sheet of material.

7. The scrubbing sponge of claim 4, wherein the scrubbing layer is made in the form of woven material.

8. The scrubbing sponge of claim 4, wherein the scrubbing layer is made in the form of non-woven material.

9. The scrubbing sponge of claim 4, wherein the scrubbing layer is heat laminated to the sponge layer.

10. The scrubbing sponge of claim 4, wherein the scrubbing layer is sewn around and over the sponge layer.
